(19) United States
(12) Patent Application Publication
(10) Pub. No.: US 2014/0283701 A1
(43) Pub. Date: Sep. 25, 2014

(54) COVER FOR A PRINTER PLATEN

(71) Applicants: Richard Lewis, Santa Maria de Palautordera (ES); Alejandro R. Cagigos, Barcelona (ES); Pedro L. Las Heras, Sant Quirze del Valles (ES); Ezequiel J. Rufes, Sant Feliu de Llobregat (ES)

(72) Inventors: Richard Lewis, Santa Maria de Palautordera (ES); Alejandro R. Cagigos, Barcelona (ES); Pedro L. Las Heras, Sant Quirze del Valles (ES); Ezequiel J. Rufes, Sant Feliu de Llobregat (ES)

(73) Assignee: HEWLETT-PACKARD DEVELOPMENT COMPANY, L.P., Houston, TX (US)

(21) Appl. No.: 14/353,571

(22) PCT Filed: Oct. 31, 2011
(86) PCT No.: PCT/US2011/058594

§ 371 Date: Apr. 23, 2014

(51) Int. Cl. B41J 11/02

(52) U.S. Cl. CPC B41J 11/02
USPC 101/407.1; 101/483

(57) ABSTRACT

A printing system comprises a printing carriage and a platen comprising vacuum holes. The platen may receive a sheet of print media. The printing system may also include a cover that rests on top of the platen and covers the vacuum holes in the platen. The cover comprises a plurality of ridges that protrude upward toward the sheet of print media being printed. The ridges define a recessed area to receive ink that passes through the print media.

### CROSS-REFERENCE TO RELATED APPLICATION

The present application is the U.S. National Stage under 35 U.S.C. §371 of International Patent Application No. PCT/US2011/058594, filed 31 Oct. 2011, the disclosure of which is hereby incorporated herein by reference.

### BACKGROUND

Many types of print media can be used when printing. Some print media, such as textile material, is relatively porous. Porous print media unfortunately may result in ink passing through the medium itself during the printing operation. Such ink should be collected in some suitable manner. One manner to collect such ink is the use of a “gutter” which is a trough that is located below the print media (i.e., on the side of the print media opposite the printing carriage). As such, the print media is spaced apart from the bottom of the gutter where the ink collects by, for example 3 inches.

Other types of print media are much less porous and do not use a gutter. Printing systems for printing on non-porous media use a platen which, like a gutter, is also positioned on the side of the print medium opposite the printing carriage. The non-porous print media passes over the platen which also functions to hold the print media down while the printing carriage passes back and forth on the opposite side. Because ink does not pass through non-porous print media, ink does not contact the platen which otherwise would coat the platen thereby marring the backside of the print media itself. Thus, generally speaking printers with platens are used to print on non-porous media whereas printers with gutters are used to print on porous media. Owning and maintaining operate two different types of printers (one for porous media and another for non-porous media) is expensive. Some printers may permit the platen to be swapped out for a gutter, and vice versa, but removing a platen and installing a gutter (and vice versa) is time consuming.

### BRIEF DESCRIPTION OF THE DRAWINGS

For a detailed description of various examples, reference will now be made to the accompanying drawings in which:

FIG. 1 shows a printing system in accordance with various examples;

FIG. 2 shows another view of a printing system in accordance with various examples;

FIG. 3 shows a top view of a platen cover in accordance with various examples;

FIG. 4 shows a side view of a portion of a platen cover in accordance with various examples;

FIG. 5 shows a close-up view of a platen in accordance with various examples;

FIG. 6 shows a close-up view of a platen with a platen cover in place in accordance with various examples; and

FIG. 7 shows a method in accordance with various examples.

### DETAILED DESCRIPTION

The following discussion is directed to various embodiments of the invention. The embodiments disclosed should not be interpreted, or otherwise used, as limiting the scope of the disclosure, including the claims.

In accordance with various embodiments, a printing system permits various types of media to be printed. A platen is installed in the printing system. For some types of print media (e.g., porous media such as textiles), a platen cover is installed on top of the platen. The platen cover collects ink that flows through the print media itself. The platen cover may be disposable and easily removed and replaced. In configurations in which the platen cover is installed, the print media is held in sufficient tension for accurate depositing of ink on the media by way of one or more rollers in the printing system.

For other types of print media (e.g., non-porous media), the cover is not used on the platen. In such embodiments, the print media is held in sufficient tension by vacuum pressure. The platen has one or more holes that are coupled to a vacuum source. Thus, when the print media passes over the platen, vacuum pressure holds the print media down in sufficient tension for printing. In the former embodiment in which the platen cover is installed, the platen cover covers the holes in the platen and thus vacuum pressure is not used to hold down the print media. In such embodiments, the vacuum holes in the platen are covered by the cover and the vacuum pressure may not be available to hold down the print media itself. In such embodiments, tension may be created by one or more rollers in the printing system to impart sufficient tension on the print media for printing with the platen cover in place.

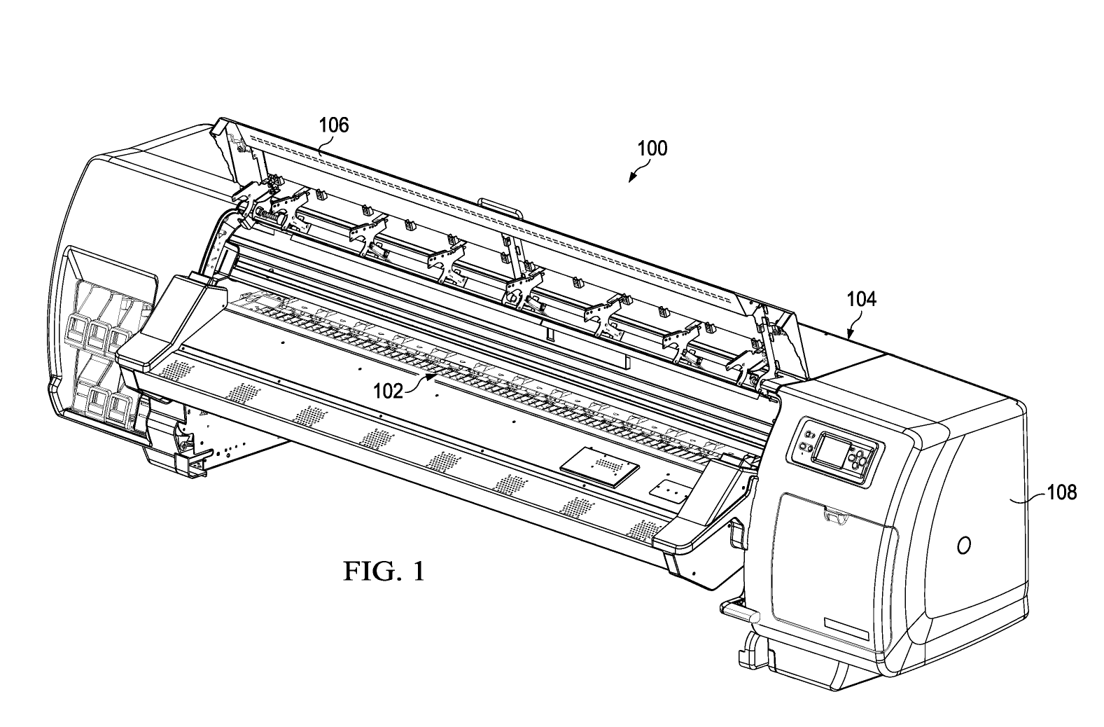

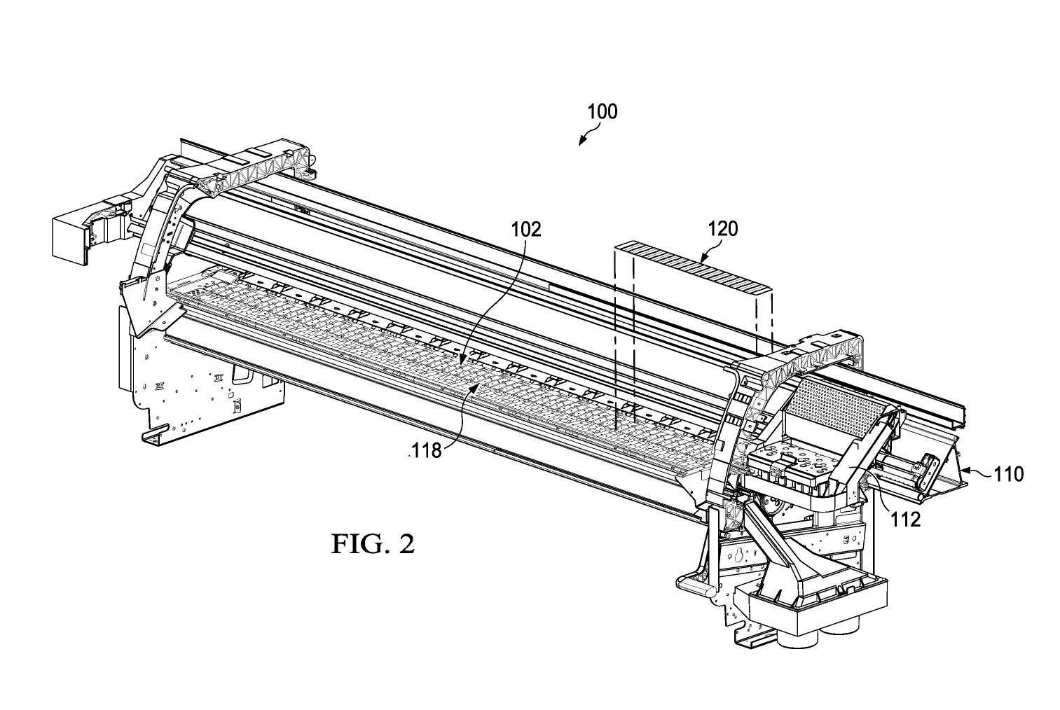

FIGS. 1 and 2 illustrate an example of a printing system 100 comprising a printer housing 104 and a hinged cover 106 (FIG. 1) which can be opened to provide access to a print zone 102. A carriage garage 108 is shown to one side of the printer housing. FIG. 2 illustrates the printing system 100 without the printer housing 104, hinged cover 106, and carriage garage 108. A printing carriage 112 (shown in FIG. 2) reciprocates back and forth along a scan beam 110 during printing. The carriage 112 comprises one or more printheads (e.g., inkjet printheads) that forces drops of ink to be ejected onto a print media below the carriage 112.

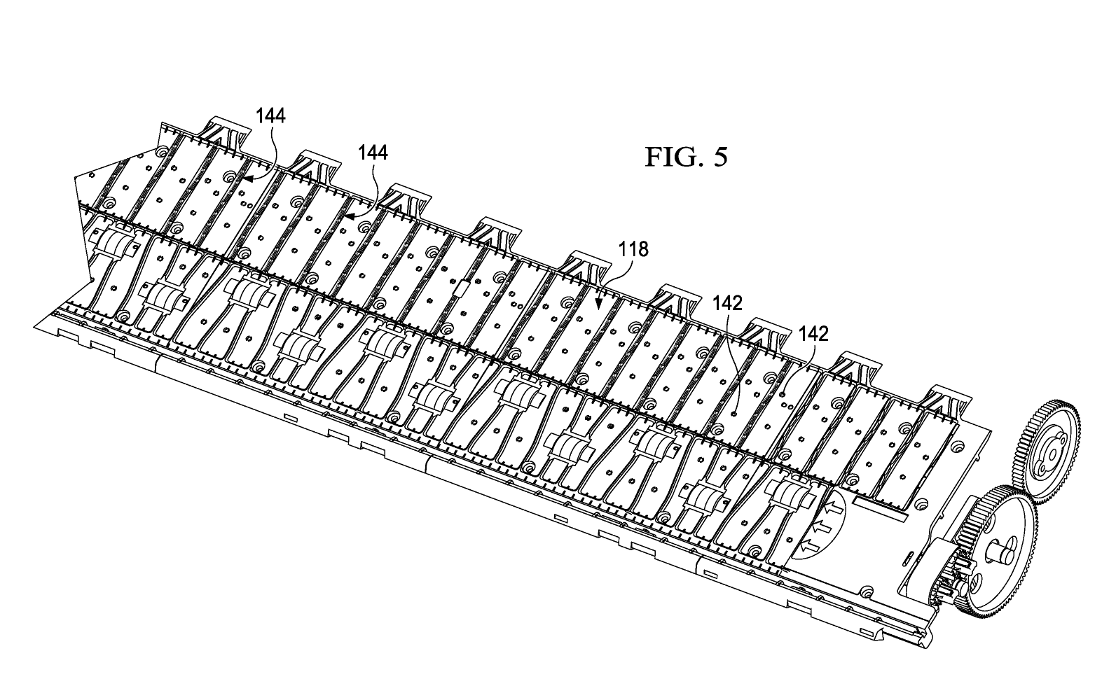

A platen 118 (FIG. 2) is provided in the print zone 102. The platen 118 comprises a rigid structure over which the print media passes. The platen 118 provides support for the print media during printing in some embodiments. The print media passes between the carriage 112 and the platen 118. The carriage 112 reciprocates back and forth across the platen 118 and ejects ink onto the print media supported by the platen. As will be discussed further in reference to FIG. 5, the platen comprises one or more vacuum holes that can be coupled to a vacuum source. The vacuum source causes a vacuum to be created at the vacuum holes on the platen 118 which causes the print media to be held down with sufficient force on the platen for printing. The types of print media that are conducive to being printed on a platen and held in place by vacuum generally comprise non-porous media (e.g., paper).

Some print media, however, is porous enough that ink will actually pass through the media from the side on which the carriage 112 is located to the opposing side of the print media adjacent the platen. Such ink that passes through the media will adhere to the platen potentially marring the side of the media on which ink is not desired.

Rather than using a gutter as noted above, various embodiments of the printing system 100 use a platen cover such as the platen cover 120 shown in FIGS. 2-4. Platen cover 120 generally comprises a thin sheet that is installed on and rests on top of the platen. In some embodiments, the platen cover 120 covers the platen's vacuum holes and is held down by the vacuum created through the vacuum holes. In such embodiments, no fasteners (e.g., screws) or tools are needed to install the platen cover 120. The platen cover 120 may span some or all of width of the platen 118. Further, the platen cover 120 may comprise multiple segments. FIG. 2 shows one such segment, and additional platen covers 120 may be placed on the platen 119 in an end-ton-end fashion to cover as much of the platen as desired. Thus, rather than one platen cover 120 that spans the entire width of the platen 118, multiple shorter platen cover segments are installed on the platen.

In some embodiments, the platen cover 120 may be slightly wider than the print media to be printed thereby permitting full bleed printing. Full bleed printing means printing slightly wider than the print media thereby enabling borderless printing.

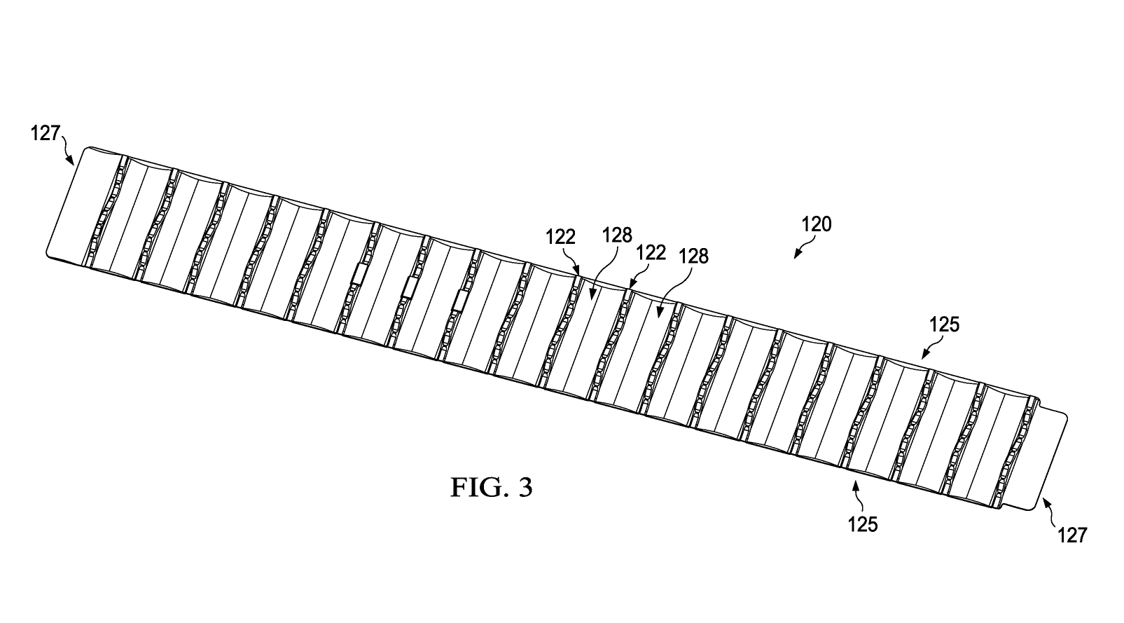

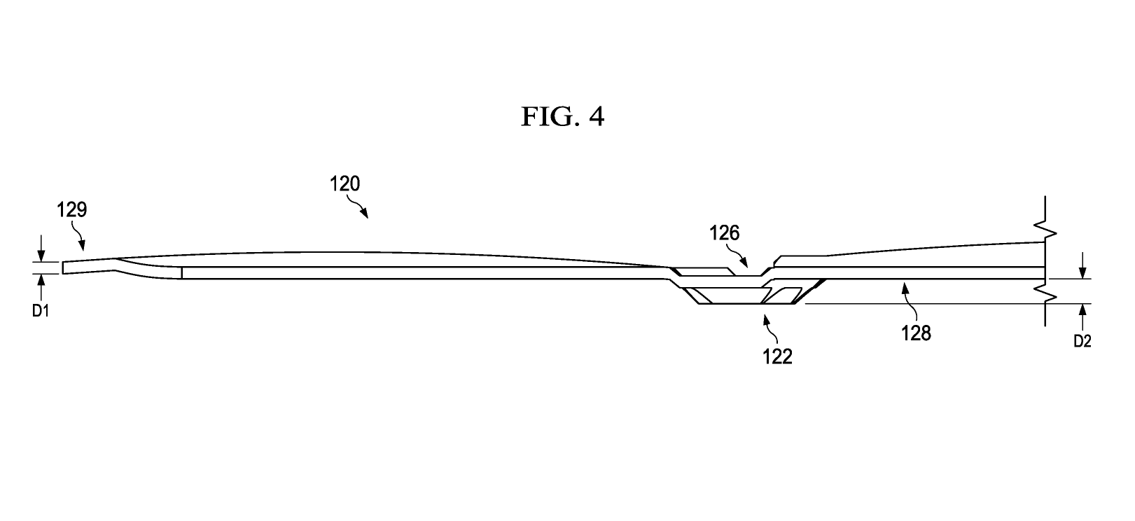

FIGS. 3 and 4 show top and side views, respectively, of an example of the platen cover 120. FIG. 3 shows a top view of an entire platen cover 120, while FIG. 4 shows a side view of one end of the platen cover. The platen cover 120 of FIGS. 3 and 4 is generally rectangular in shape having a pair of opposing long sides 125, as well as a pair of opposing short sides 127. The platen cover 120 comprises multiple ridges 122 that define a recessed area 128 between the ridges. Ink that falls on to the platen cover 120 collects in the recessed areas 128 between the ridges 122. In the example of FIGS. 3 and 4, the ridges 122 of the platen cover 120 comprise multiple elongated ridges that extend between the long sides 125 of the cover. Each ridge comprises multiple spaced apart protrusions or may comprise a solid elongated member. The ridges 122 are generally parallel to one another and define multiple recessed areas 128 between adjacent pairs of such ridges 122. In FIG. 3, 18 recessed areas 128 are defined by 19 parallel ridges 122. As such, ink can collect in any or all of the 18 recessed areas. Other embodiments of the platen cover 120 have a number of ridges 122 and recessed areas 128 different than 18 and 19, respectively. Generally, a platen cover 120 has at least one recessed area 128 defined by at least two ridges 122. For example, the platen cover 120 may have at least three ridges 122 that define recessed areas 128 between such ridges.

FIG. 4 shows an example of one end 129 of the platen cover (the end corresponding to the short sides 127). In this example, the end 129 has an angle to it thereby creating a lip. The opposing side of the platen cover has a similar lip but angled in the opposite direction. The angled lips permit two platen covers 118 to be positioned side-by-side with a slight overlap.

The platen cover 120 can be formed from any suitable material. Suitable examples of such materials include polystyrene (PS). The platen cover 120 may be formed of a material different from the material from which the platen is constructed and at least different from the material comprising the surface of the platen 118 that receives the platen cover 120. The platen cover 120, in some examples, has a small enough thickness D1 (FIG. 4) that printing is not disrupted with the added thickness of the platen cover 120. For example, the platen cover 120 may have thickness D1 of about 0.3mm (e.g., 0.3mm +/−10%). Each ridge 122 extends a distance D2 from the surface of the platen cover. In some examples, D2 is about 1.4 mm (e.g., 1.4mm +/−10%), but can be other than 1.4 mm in other examples. In examples in which D2 is 1.4 mm, the depth of the recessed areas 128 also is 1.4 mm as the ridges 122 define the recessed areas. Both vacuum and magnetic attraction may cooperate to hold the platen cover 120 in place in yet other embodiments.

In some embodiments, as noted above, the platen cover 120 is held in place on the platen 118 by vacuum pressure through vacuum holes provided in the platen itself. In other embodiments, the platen cover 120 is held in place, at least in part, by magnetic attraction between the platen cover 120 and the platen 118. For example, the platen cover 120 may be formed of a magnetic material that is attracted to the platen 118, or the platen 118 may be formed of magnetic material that is attracted to the platen cover 120. In yet other embodiments, magnets may be provided on the platen cover 120 and/or the platen 118 to create the magnetic attraction between the two.

FIG. 5 shows a close-up view of the platen 118 without the platen cover 120. As can be seen, the platen has multiple vacuum holes 142 formed therein through which vacuum is applied to retain print media or the platen cover 120 in place depending on the type of print media being printed. The platen 118 also comprises multiple ridges 144 (i.e., 2, 3, or more ridges). Each ridge comprises multiple spaced apart protrusions or each ridge may comprise a solid elongated member. FIG. 4 illustrates that each ridge 122 on the platen cover defines a cavity 126 behind the ridge 122, and each such cavity 126 may fit on a corresponding ridge 144 of the platen 118.

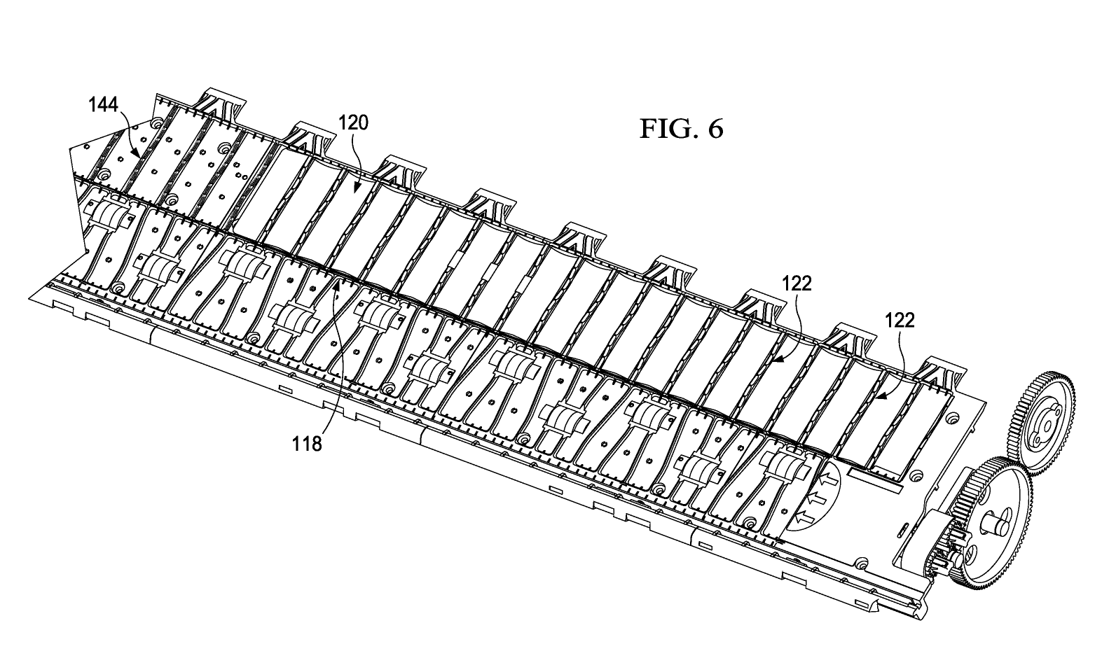

FIG. 6 illustrates the platen 118 with the platen cover 120 in place in close contact with the platen 118. As can be seen, the ridges 122 of the platen cover 120 coincide with the ridges 144 on the platen 118. That the platen cover ridges 122 coincides with the platen ridges 144 helps to mechanically register the platen cover 120 in the correct place on the platen 118.

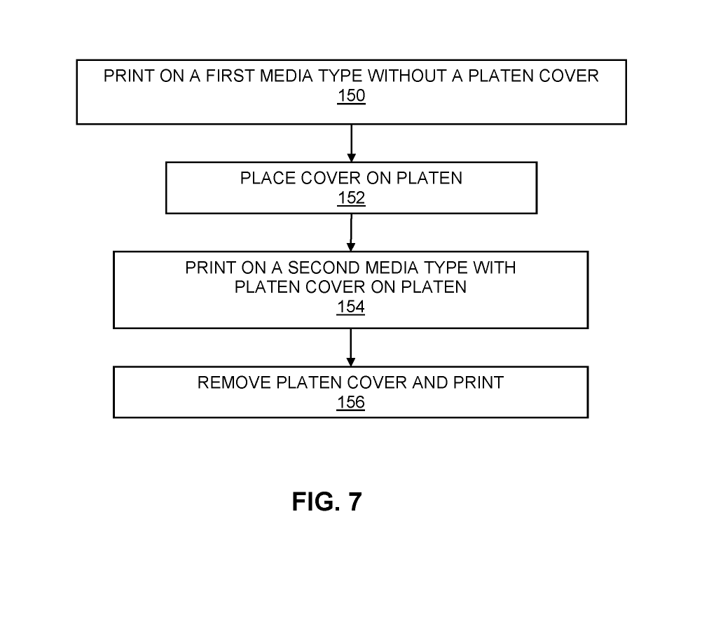

The use of the platen cover 120 permits multiple types of print media (e.g., porous and non-porous) to be printed with the same printing system. A gutter is not needed when printing on porous media. Instead, the print cover 120 is installed on the platen 118. FIG. 7 provides a method in which the different types of media are printed on the same printing system with the inclusion or removal of the platen cover 120.

At 200, the method comprises printing on a first media type (e.g., non-porous media) without the platen cover 120 in place on the platen 18. A decision then is made to continue printing but on a different type of print media such as porous media. Accordingly, at 202 the method comprises placing the platen cover 120 in place on the platen 118. This action may comprise raising the hinged cover 106 on the printer and placing one or more platen covers 120 on the platen 118. Tools may not be needed to install the platen cover in some embodiments. At 154, the method comprises printing on a second type of print media (e.g., porous) with the platen cover 120 in place on the platen 118. Further, the platen cover can be removed and reinstalled as many times as desired depending on the type of print media to be printed. Action 156 illustrates, the removal of the platen cover 120 and subsequent printing on a print media (e.g., the first type of print media referred to at 150).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A printing system, comprising:
a printing carriage;
a platen comprising vacuum holes, said platen to receive a sheet of print media; and
a cover that rests on top of said platen and covers said vacuum holes, said cover comprises a plurality of ridges that protrude upward toward said sheet of print media, said ridges defining a recessed area to receive ink that passes through said print media.

2. The printing system of claim 1 wherein said cover comprises polystyrene.

3. The printing system of claim 1 wherein said cover is made of a different material than the platen.

4. The printing system of claim 1 wherein said cover is removed when said printing system is used to print on non-porous print media, but placed on said platen when the printing system is used to print on porous print media.

5. The printing system of claim 1 wherein said ridges on the cover are arranged to coincide with the ridges on the platen.

6. The printing system of claim 1 wherein said cover is about 0.3 mm thick.

7. The printing system of claim 1 wherein said plurality of ridges comprise at least three ridges, each ridge having multiple spaced apart protrusions, and the recessed area comprises multiple recessed areas, one recessed area between adjacent ridges.

8. The printing system of claim 1 wherein said recessed area has a depth of about 1.4 mm.

9. The printing system of claim 1 wherein said cover is held in place on said cover, at least in part, by magnetic attraction between said cover and said platen.

10. A printing system, comprising:
a printing carriage;
a platen to receive a sheet of print media, said platen comprising a plurality of platen ridges; and
a cover that rests on top of said platen, said cover comprising a plurality of ridges that define a recessed area to receive ink that passes through said print media from said printing carriage, said ridges on the cover coincide with the platen ridges

11. The printing system of claim 10 wherein said cover is removed when said printing system is used to print on non-porous print media, but placed on said platen when the printing system is used to print on porous print media.

12. The printing system of claim 10 wherein said platen ridges comprises at least three platen ridges, and the ridges on said cover comprise at least three ridges that coincide with said platen ridges.

13. The printing system of claim 10 wherein said platen comprises a vacuum hole that is covered by said cover.

14. A method, comprising:
printing on a first media type without a cover on a platen;
placing the cover on the platen; and
printing on a second media type with the cover on the platen.

15. The method of claim 14 wherein placing the cover on the platen comprises aligning indentations on the cover with ridges on said platen.
